(19) United States
(12) Patent Application Publication
(10) Pub. No.: US 2008/0094866 A1
(43) Pub. Date: Apr. 24, 2008

(54) CAPACITOR-SWITCHED LOSSLESS SNUBBER

(76) Inventors: Jennifer Bauman, Waterloo (CA); Mehrdad Kazerani, Waterloo (CA)

Correspondence Address: MILLER THOMPSON, LLP, Scotia Plaza, 40 King Street West, Suite 5800, TORONTO, ON, M5H 3S1, CA

(21) Appl. No.: 11/774,208

(22) Filed: Jul. 6, 2007

Related U.S. Application Data
(60) Provisional application No. 60/818,537, filed on Jul. 6, 2006.

(51) Int. Cl. H02H 7/10

(52) U.S. Cl. 363/50

(57) ABSTRACT

A regenerative snubber circuit for a boost converter is provided which greatly reduces the switching losses of the IGBT in the converter. The circuit uses no additional magnetic components, has a simple control strategy, is relatively low-cost, and provides an increase in efficiency and decrease in size and mass of the converter.

This application claims priority from U.S. Provisional Patent Application No. 60/818,537, filed Jul. 6, 2006.

### TECHNICAL FIELD

The present invention relates to DC/DC power converters. In particular, the present invention relates to a regenerative snubber for a boost converter.

### BACKGROUND OF THE INVENTION

High power DC/DC converters are a crucial component of emerging vehicle technologies, including hybrid-electric, battery-electric, and fuel cell vehicles, to interconnect and manage their power systems. Typically, a voltage boost effected by a boost converter is required to step-up the lower voltage provided by a fuel cell or battery to the higher voltage required by the vehicle's electric motor. However, conventional high-power boost converters are very large and heavy, partly due to the large inductors used in the design. These heavy components negatively affect the fuel economy of the vehicles, add cost to the vehicle, and may add difficulty for packaging.

In emerging vehicle technologies, reducing the size and mass of the converter allows easier packaging and provides higher fuel economy. High-efficiency operation is also crucial to further improve the fuel economy. The solution is to implement a method which reduces the switching losses in the converter so that the switching frequency can be increased and hence the size of the inductors and overall converter can be reduced. The converter should be a simple, low-cost design to operate reliably for all possible loads.

High specific power and high power density require high-frequency operation, which may lead to two potential problems for high-power (30 kW-100 kW) DC/DC converters. Firstly, switching losses will increase proportionally with increasing frequency, which will reduce efficiency and increase cooling requirements. Secondly, the power insulated gate bipolar transistors (“IGBTs”) commonly used in these converters are limited to hard-switching operation at 30 kHz or less [Powerex CM400DU-12NFH datasheet, www.pwrx.com], depending on power level. If soft-switching is used, switching losses are reduced and these IGBTs can operate at frequencies up to 70 kHz [Powerex], which can significantly reduce the size of filter components in the converter, without increasing heat sink size.

In recent years, a number of techniques and circuits have been proposed to reduce switching losses in DC/DC converters. In resonant and quasi-resonant converters, the devices are turned off, turned on, or both, at zero-voltage or zero-current of a resonant mode [K. H. Lui, F. C. Lee, “Zero Voltage Switching Technique in DC/DC Converters”, IEEE Trans. on Power Electronics, vol. 5, pp. 293-304, July 1990; O. D. Patterson and D. M. Divan, “Pseudo-Resonant Full Bridge DC/DC Converter”, IEEE Trans. on Power Electronics, vol. 6, pp. 671-678, October 1991; Q. Li and P. Wolfs, “An Analysis of the ZVS Two-Inductor Boost Converter Under Variable Frequency Operation,” IEEE Trans. on Power Electronics_{, vol.} 22, pp. 120-131, January 2007]. However, resonant converters require careful matching of the operating frequency to the resonant tank components and operation failure can occur if there is any magnetic saturation or other unexpected drift in resonant frequency. Furthermore, it is difficult to design filters and control circuits because of the wide range of switching frequencies.

Passive soft-switching methods [M. D. Bagewadi, B. G. Fernandes, and R. V. S. Subrahmanyam, “A Novel Soft Switched Boost Converter Using a Single Switch,” Proc. of IEEE Power Electronics and Motion Control Conference, Aug. 15-18, 2000, Beijing, China, p. 412-416; K. Smith and K. Smedley, “Properties and Synthesis of Passive Lossless Soft-Switching PWM Converters,” IEEE Trans. on Power Electronics, vol. 14, pp. 890-899, September 1999; E. S. da Silva, L. dos Reis Barbosa, J. B. Vieira, L. C. de Freitas, and V. J. Farias, “An Improved Boost PWM Soft-Single-Switched Converter With Low Voltage and Current Stresses,” IEEE Trans. on Industrial Electronics, vol. 48, pp. 1174-1179, December 2001; B. T. Irving and M. M. Jovanovic, “Analysis, Design, and Performance Evaluation of Flying-Capacitor Passive Lossless Snubber Applied to PFC Boost Converter,” Proc. of IEEE Applied Power Electronics Conference, Mar. 10-14, 2002, Dallas, pp. 503-508; C.-L. Chen and C.-J. Tseng, “Passive Lossless Snubbers for DC/DC Converters,” Proc. of IEEE Applied Power Electronics Conference, Feb. 15-19, 1998, Anaheim, pp. 1049-1054] use only passive components to achieve zero-voltage or zero-current switching at a constant switching frequency. The auxiliary circuits can be very complicated and require numerous extra components, usually including extra magnetic components. Also, many of the proposed methods are designed for low-power boost converters using MOSFETs and hence focus on reducing the reverse-recovery losses during turn-on of the switch (due to the boost diode) rather than the more significant turn-off losses found in high-power converters using IGBTS. However, new silicon carbide (SiC) diodes have nearly zero reverse-recovery current, so can now be implemented as the boost diode to virtually eliminate turn-on losses of the switch [M. Janicki, D. Makowski, P. Kedziora, L. Starzak, G. Jablonski, and S. Bek, “Improvement of PFC Boost Converter Energy Performance Using Silicon Carbide Diode,” Proc. of the IEEE Conference on Mixed Design of Integrated Circuits and System, Jun. 22-24, 2006, Gdynia, pp. 615-618]. Finally, passive methods can cause higher component stresses and have generally been shown to provide only marginal reductions in switching losses. For example, in [C.-L. Chen and C.-J. Tseng], the converter efficiency is not compared to the hard-switched version of the boost converter. The snubber capacitor is charged from the output capacitor at turn-on, then discharged back to the output capacitor at turn-off. Thus, there is room for improvement in this scheme, specifically, to find a method which provides a soft turn-off of the switch without taking energy from the output capacitor to do so.

Active soft-switching methods [G. Yao, A. Chen, and X. He, “Soft Switching Circuit for Interleaved Boost Converters,” IEEE Trans. on Power Electronics, vol. 22, pp. 80-86, January 2007; C. M. de Oliveira Stein, J. R. Pinheiro, and H. L. Hey, “A ZCT Auxiliary Commutation Circuit for Interleaved Boost Converters Operating in Critical Conduction Mode,” IEEE Trans. on Power Electronics, vol. 17, pp. 954-962, November 2002; R. Gurunathan, A. K. S. Bhat, “A Zero-Voltage Transition Boost Converter Using a Zero-Voltage Switching Auxiliary Circuit,” IEEE Trans. on Power Electronics, vol. 17, pp. 658-668, September 2002; A. Van den Bossche, V. Valtchev, J. Ghijselen, and J. Melkebeek, “Soft-switching Boost Converter for Medium Power Applications,” Proc. of IEEE Power Electronic Drives and Energy Systems for Industrial Growth, Dec. 1-3, 1998, Perth, Australia, pp. 1007-1012; X. Wu, X. Ye, J. Zhang, Z. Qian, “A New Zero Voltage Switching Boost DC/DC Converter With Active Clamping,” Proc. of IEEE Applied Power Electronics Conference, Mar. 6-10, 2005, Austin, pp. 406-412; J.-H. Kim, D. Y. Lee, H. S. Choi, and B. H. Cho, “High Performance Boost PFP (Power Factor Pre-Regulator) with an Improved ZVT (Zero Voltage Transition) Converter,” Proc. of IEEE Applied Power Electronics Conference, Mar. 4-8, 2001, Anaheim, pp. 337-342; Y. Jang, M. M. Jovanović, and D. L. Dillman, “Soft-Switched PFC Boost Rectifier with Integrated ZVS Two-Switch Forward Converter,” IEEE Transactions on Power Electronics, vol. 21, no. 6, November 2006; Y. Jang, M. M. Jovanovic, K.-H. Fang, and Y.-M. Chang, “High-Power-Factor Soft-Switched Boost Converter,” IEEE Trans. on Power Electronics, vol. 21, pp. 98-104, January 2006; Y. Jang, M. M. Jovanovic, and C. Wen, “Design Considerations and Performance Evaluation of a 3-kW, Soft-Switched Boost Converter with Active Snubber,” Proc. of Telecommunications Energy Conference, Oct. 4-8, 1998, San Francisco, pp. 678-684; M. Jovanovic, Y. Jang, “A New, Soft-Switched Boost Converter with Isolated Active Snubber,” IEEE Trans. on Industry Applications, vol. 35, pp. 496-502, March/April 1999; B. Ivanovic and Z. Stojiljkovic, “A Novel Active Soft Switching Snubber Designed for Boost Converters,” IEEE Trans. on Power Electronics, vol. 19, pp. 658-665, May 2004] use one or more auxiliary switches in addition to passive components to achieve zero-voltage or zero-current switching. Some disadvantages of active methods are in complexity of control or limitations in terms of voltage-boost range and load range. Many active methods proposed also focus on the reverse recovery losses at turn-on of the main switch, though this problem can be remedied through the use of SiC boost diodes. Finally, some active methods have hard-switching of the auxiliary switch(es) and many have a high component count, including heavy and expensive inductors. There is a need for a simple and efficient method for increasing the switching frequency of high-power boost converters.

### SUMMARY OF THE INVENTION

In a power converter having a power switch, a snubber circuit comprising: a snubber capacitor; first and second snubber diodes; a first auxiliary switch that, upon a first turn off of the power switch, conducts current through the first snubber diode and the snubber capacitor to charge the snubber capacitor; and a second auxiliary switch that upon a subsequent turn off of the power switch, conducts current through the second snubber diode and the snubber capacitor to discharge the snubber capacitor.

A method for minimizing switch off losses in a power converter having an input current, a power switch set in an on position and a snubber circuit, the snubber circuit having a first auxiliary switch, a second auxiliary switch, a snubber capacitor, and first and second snubber diodes, the method comprising the steps of: i) setting the first auxiliary switch to an on position and the second auxiliary switch to an off position; ii) charging the snubber capacitor from zero V to Vₒᵤₜ by setting the power switch to an off position to divert the current through the first snubber diode, the snubber capacitor and the first auxiliary switch; iii) setting the first auxiliary switch to an off position; iv) setting the power switch to the on position; v) setting the second auxiliary switch to an on position; vi) discharging the snubber capacitor from Vₒᵤₜ to zero V by setting the power switch to the off position to divert the current through the second snubber diode, the snubber capacitor and the second auxiliary switch; and vii) repeating steps i) through vii).

A power converter having a snubber circuit, the snubber circuit comprising: a snubber capacitor; first and second snubber diodes; a first auxiliary switch that, upon a first turn off of the power switch, conducts current through the first snubber diode and the snubber capacitor to charge the snubber capacitor; and a second auxiliary switch that upon a subsequent turn off of the power switch, conducts current through the second snubber diode and the snubber capacitor to discharge the snubber capacitor.

There is provided a capacitor-switched regenerative snubber for high-power boost converters. The circuit is simple, highly efficient, operates over the entire load range, and has a straightforward control strategy which does not require any additional sensors or feedback. Also, as high-power magnetic components comprise a significant portion of a circuit's mass, volume, and cost, the capacitor-switched regenerative snubber circuit is designed to require no additional magnetic components. The only additional components required are two IGBTs (which are connected as a leg, and can be easily implemented as a dual IGBT module), two diodes, and one snubber capacitor. Simulation and experimental results show that the capacitor-switched regenerative snubber circuit drastically reduces turn-off losses of the main switch. Turn-on losses can be virtually eliminated by the use of zero-reverse-recovery silicon carbide diodes. The auxiliary switches are switched at zero-voltage conditions and hence introduce no switching losses to the converter.

There is further provided an active soft-switching method using the capacitor-switched regenerative snubber.

In one aspect of the present invention, a boost converter in accordance with the present invention provides relatively high switching frequencies than prior art boost converters, with desirable converter efficiencies. The regenerative snubber of the present invention is relatively light in comparison with prior art hard-switched converters due to the smaller passive components required at a higher frequency. Other benefits of using the regenerative snubber circuit of the present invention include: lower switch stress at turn-off and turn-on, a lower duty cycle required for the equivalent voltage boost in the hard-switched converter, and the transfer of much of the switching losses to conduction losses in the auxiliary components, meaning switching frequency may generally be greatly increased before reaching the thermal limits of the IGBT. The regenerative snubber for boost converters of the present invention may not pose any practical limitations in terms of operating power or voltage boost. The regenerative snubber of the present invention has a relatively simple design and is relatively easily controlled. It provides relatively high efficiency and relatively desirable mass reduction. It is suited for a variety of applications such as fuel cell, hybrid-electric, and battery-electric vehicles, uninterruptible power supplies (UPS), and stationary generators requiring a voltage boost to connect to the grid such as fuel cells, photovoltaic arrays, and microturbines.

### BRIEF DESCRIPTION OF THE DRAWINGS

A detailed description of the preferred embodiments is provided by way of example only and with reference to the following drawings, in which:

FIG. 1 is a schematic of a conventional boost converter;

FIG. 2 is a schematic of a boost converter with regenerative snubber, as in the present invention;

FIG. 3 is a schematic of a boost converter with regenerative snubber, depicting current flow during initial turn-off charging snubber capacitor;

FIG. 4 is a schematic of a boost converter with regenerative snubber, depicting current flow during any turn-on of S₁;

FIG. 5 is a schematic of a boost converter with regenerative snubber, depicting current flow during subsequent turn-off discharging snubber capacitor;

FIG. 6 is a schematic depicting the required gating signals for the 3 switches in the regenerative snubber boost converter;

FIG. 7 is a chart depicting the simulation results for the regenerative snubber converter: (a) gating signals, (b) voltage and current of main and (c, d) auxiliary switches, and (e) voltage and current of snubber capacitor;

FIG. 8 is a schematic depicting the hard-switched converter prototype;

FIG. 9 is a schematic depicting the capacitor-switched regenerative snubber converter prototype;

FIG. 10 is a chart depicting voltage across and current through the switch for a hard-switched converter;

FIG. 11 is a chart depicting voltage across and current through the main switch for the regenerative snubber converter of the present invention;

FIG. 12 is a chart depicting voltage across and current through the switch for the hard-switched converter at turn-off;

FIG. 13 is a chart depicting voltage across and current through the main switch for the regenerative snubber converter of the present invention at turn-off;

FIG. 14 is a chart depicting voltage across and current through the switch for the hard-switched converter at turn-on;

FIG. 15 is a chart depicting voltage across and current through the main switch for the regenerative snubber converter of the present invention at turn-on;

FIG. 16 is a chart depicting voltage across and current through the auxiliary switch (S₂) and the voltage across the snubber capacitor;

FIG. 17 is a chart depicting voltage across and current through the auxiliary switch (S₃) and the voltage across the snubber capacitor; and

FIG. 18 is a chart depicting a comparison of efficiency measurements for the hard-switched and regenerative snubber converters.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

Circuit Design

An analysis is performed on a high-power hard-switched boost converter in order to compare the turn-on and turn-off losses of the switch. A boost converter with specifications similar to what is used in fuel cell or electric vehicles (200V input, 400V output, 60 kW) was simulated in PSPICE. The part number for the IGBT model used is CM400HA-12E. In order to obtain practical results, the gate resistance is chosen to limit the maximum gate current to 10% of the rated current of the switch. The simulation results show that the energy loss at turn-on is approximately 2 mJ, whereas the energy loss at turn-off is approximately 21 mJ.

The much higher value of turn-off losses in an IGBT can be explained by the fact that there is a significant current tail as the voltage across the switch rises rapidly during turn-off. Hence, the capacitor-switched regenerative snubber circuit described herein focuses on reducing the turn-off losses of the IGBT. However, the design of the present invention, in one aspect thereof, uses of silicon-carbide diodes to reduce the turn-on losses and hence improve the overall efficiency of the converter at high switching frequencies. Silicon-carbide diodes reduce turn-on losses in a boost converter because they exhibit nearly zero reverse recovery current when turning off [Janicki et. all].

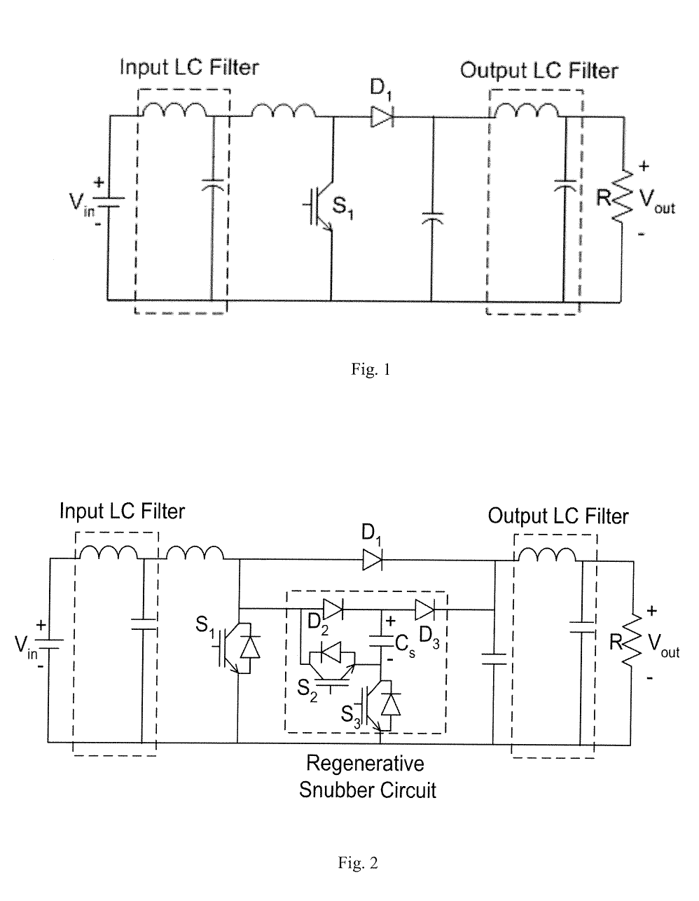

The circuit diagram of a conventional boost converter is shown in FIG. 1, complete with input and output filters to smooth current and voltage ripple. One particular implementation of the regenerative snubber circuit is shown in FIG. 2. The idea is to charge the snubber capacitor Cₛ at one turn-off and then discharge the snubber capacitor at the next turn-off. With this operation, the voltage rise across the switch is slowed down and the current tail through the switch is reduced at each turn-off, and virtually all of the energy used to accomplish this is returned to the output circuit. To realize this operation, the connection of the snubber capacitor to the main switch S₁ must be reversed for every turn-off, so that the charging and discharging actions are bringing the voltage across the snubber capacitor from 0V to Vₒᵤₜ and vice versa. The details of the circuit operation are described below.

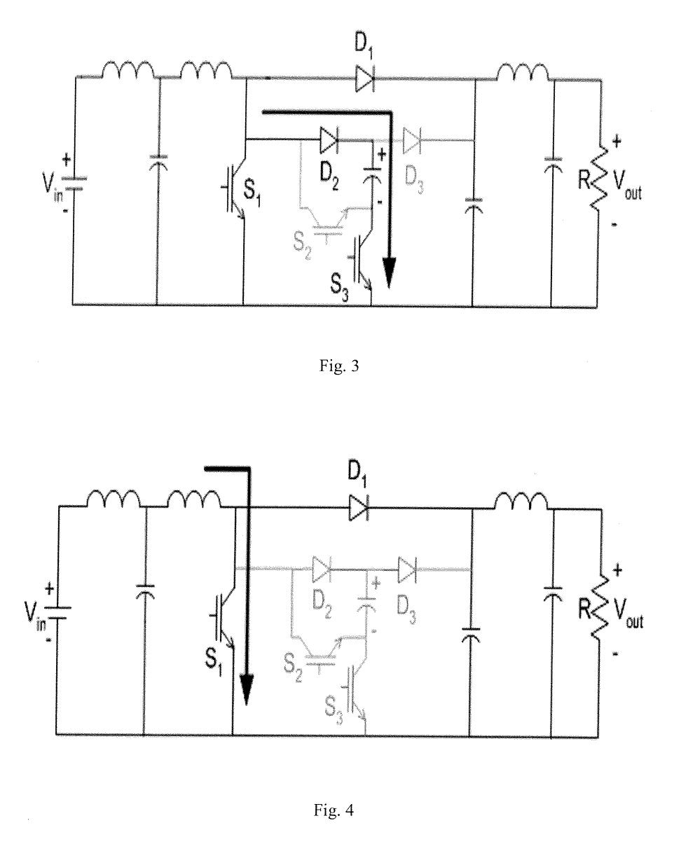

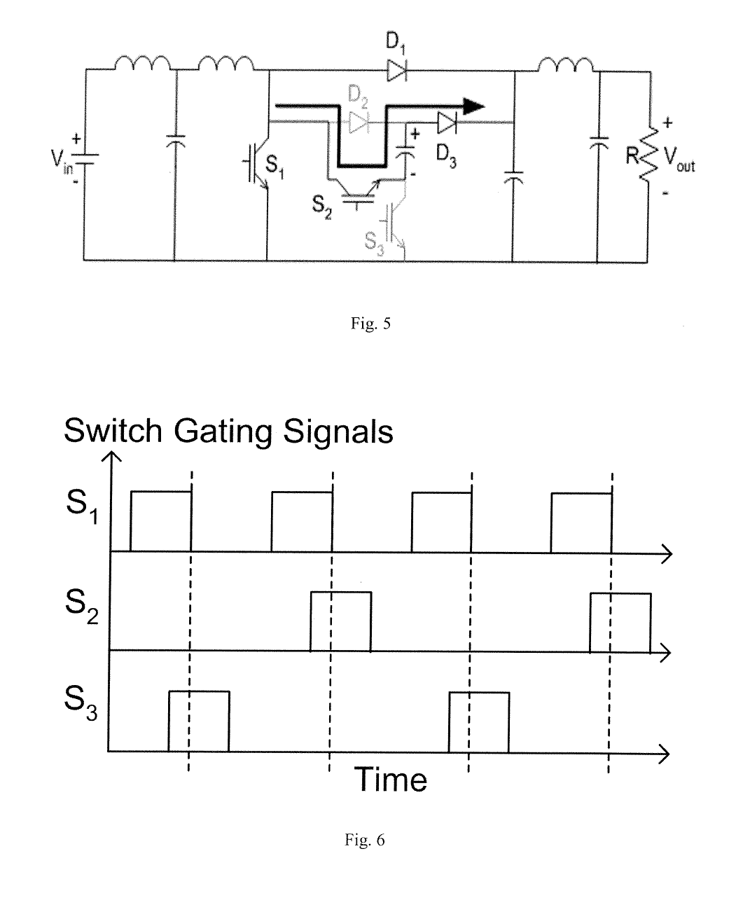

At the first turn-off of S₁, shown in FIG. 3, S₃ is on and S₂ is off so that current flows through D₂ and S₃ to charge the snubber capacitor Cₛ from 0V to the output voltage Vₒᵤₜ. This charging action slows down the voltage rise across switch S₁, greatly reducing the losses while the current in the switch S₁ falls quickly. At the next turn-on, both S₂ and S₃ are off as shown in FIG. 4; thus, the operation of S₁ at turn-on is virtually unaffected by the snubber circuit. At the next turn-off of S₁ (shown in FIG. 5), S₂ is on and S₃ is off; thus, the current flows through S₂ and D₃ to discharge the snubber capacitor. Again, this action greatly slows down the voltage rise across S₁ and reduces the current tail through S₁. All the energy stored in the snubber capacitor is transferred to the output of the circuit, leading to a very efficient design.

The only losses introduced into the converter by the snubber circuit are the short pulses of conduction loss in the auxiliary diodes and switches. Both auxiliary switches turn on and off under zero-voltage conditions due to the nature of the circuit; thus, virtually no switching losses are introduced [J. Marshall and M. Kazerani, “A Novel Lossless Snubber for Boost Converters”, IEEE International Symposium on Industrial Electronics, Jul. 9-13, 2006, Montreal, pp. 1030-1035.]. The additional conduction losses are very small in comparison with the reduction in the losses of the main switch at turn-off.

Control Strategy

The control strategy for operating the main and auxiliary switches is simple and can be implemented on a microcontroller. No additional sensors or feedback are required for the auxiliary switches. FIG. 6 shows required gating signals. The auxiliary switches must turn on before the main switch turns off and they must turn off before the main switch turns back on. The auxiliary switches have a constant duty cycle to facilitate charging (S₃ on) and discharging (S₂ on) of the snubber capacitor. The duty cycle of the main switch can be changed by changing the turn-on time, while keeping the turn-off time in sync with the auxiliary switch turn-on times.

The boost converter is not practical for use with very high voltage boosts (due to parasitic losses) and so very high duty cycles are not usually required. Thus, the fact that the snubber capacitor must finish charging or discharging before switch S₁ turns on does not pose any limitation in most practical cases. If a high voltage boost is required, the design choice of the snubber capacitor size can be made to ensure the required duty cycle is obtainable without violating the control strategy principles.

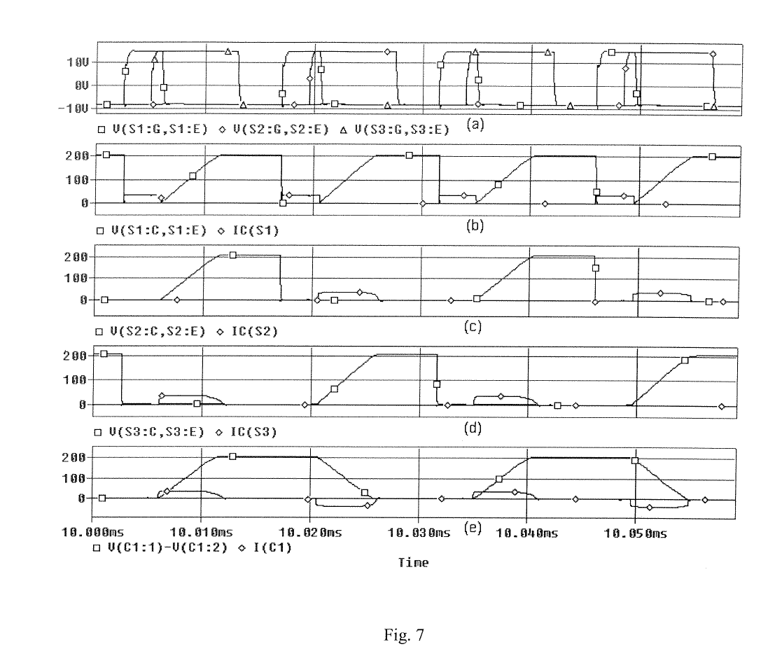

Simulations were performed using PSPICE to characterize the behaviour of a 5-kW prototype of the present invention. The results are shown in FIG. 7 to illustrate the timing of the gating signals for the 3 switches in the converter and the voltages across and currents through the switches and the snubber capacitor. FIG. 7 shows that there are no switching losses associated with the auxiliary switches, since they always turn on and off at zero current due to the nature of the circuit. The conduction losses in the auxiliary switches are small compared to the reduction in power loss of the main switch during turn-off.

A microcontroller was programmed with the control strategy for use with the experimental prototypes. To decouple any effects caused by a closed-loop controller from the circuit behavior, open-loop control was implemented. A potentiometer was used to alter the 5V signal entering an A/D port on the microcontroller. When the analog signal is above 1V, the auxiliary switch gating signals became active and switched at 35 kHz, and phase shifted 180° from one another (the phase shift was accomplished by delaying when the PWM output channel was enabled). The auxiliary switches have a constant duty cycle, which can be determined through simulation and depends on the converter current and voltage, as well as snubber capacitance. A closed-loop current or voltage control scheme can be easily implemented, as the only change would be that a software control loop would control the main switch duty cycle rather than an analog signal from the potentiometer.

Experimental Prototype

In order to perform a comprehensive comparison between the capacitor-switched regenerative snubber boost converter and the hard-switched boost converter in terms of mass, switch stress, and efficiency, two 5-kW boost converters, one with and the other without the snubber circuit, were designed, built, and tested. The specific IGBT used was chosen because it is a new model capable of high-frequency operation due to its short turn-on and turn-off times. Using the best switches available on the market ensures the comparison between the two converters is relevant. Selected specifications from the IGBT datasheet are shown in Table I. The switching frequency for the capacitor-switched regenerative snubber converter was chosen to be 70 kHz (the maximum frequency allowable for the IGBT under soft-switching conditions due to thermal restrictions) and the switching frequency for the hard-switched converter was chosen to be 30 kHz (the maximum frequency allowable for the IGBT under hard-switching conditions due to thermal restrictions). The simulation results showed that at these specified frequencies, the efficiencies of the two converters would be approximately equal.

TABLE I
IGBT SPECIFICATIONS: CM150DUS-12F

| | | |
|---|---|---|
| Maximum Collector-Emitter Voltage, V_{CES} | 600 | V |
| Maximum Collector Current, I_{C} | 150 | A |
| Turn-On Delay Time, t_{d(on)} | 120 | ns |
| Rise Time, tᵣ | 100 | ns |
| Turn-Off Delay Time, t_{d(off)} | 350 | ns |
| Fall Time, t_{f} | 150 | ns |

The hard-switched converter and the capacitor-switched regenerative snubber converter use the exact same IGBTs, drivers, diodes (silicon carbide diodes to reduce turn-on losses), filter capacitors, and boost capacitors. Care was taken to minimize the length of wires between components in both converters, and thus the parasitic inductance was minimized as much as possible for a prototype circuit. The input filter inductors and boost inductors were custom-made for each converter by a magnetics company. The input LC filter for each converter uses a 2.2 mF electrolytic capacitor, and the inductor values were determined based on choosing the filter's resonant frequency to be approximately one decade below the switching frequency of each converter. The inductance of the main boost inductors for each converter was chosen to make the inductor current ripple approximately 3 A (6.4%) at full power (47 A input current). The output L-C filter was omitted to simplify the prototype construction. According to the PSPICE simulations, the auxiliary switches have peak and RMS current ratings that are slightly lower than those of the main switch [22].

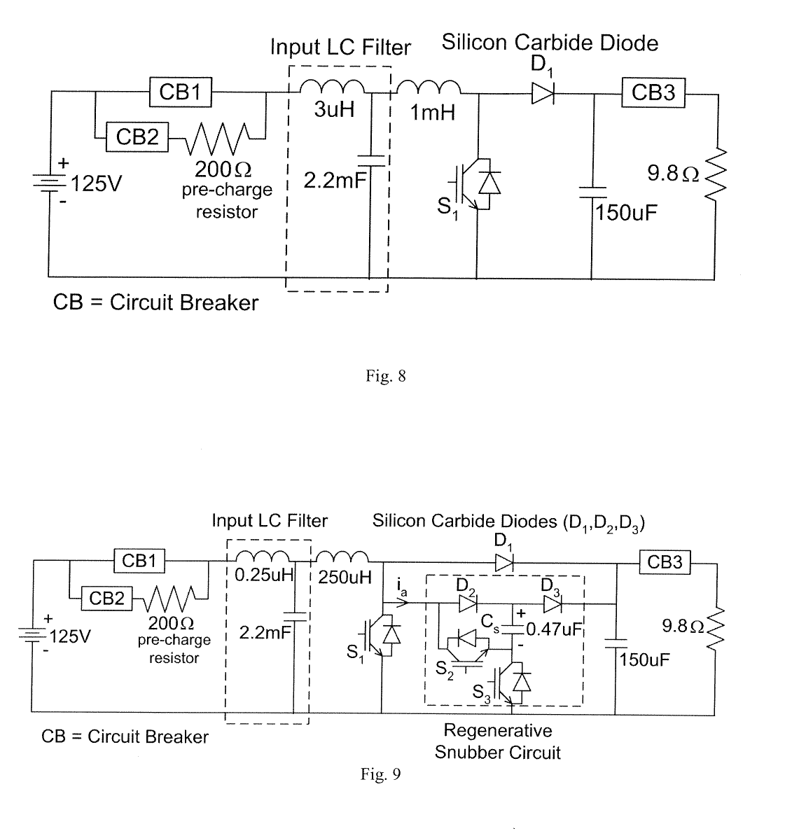

However, the same IGBTs were used for the auxiliary and main switches to minimize the number of different parts required. The circuit diagrams of the experimental set-ups are shown in FIGS. 8 and 9 for the hard-switched and regenerative snubber converters respectively.

Experimental Results

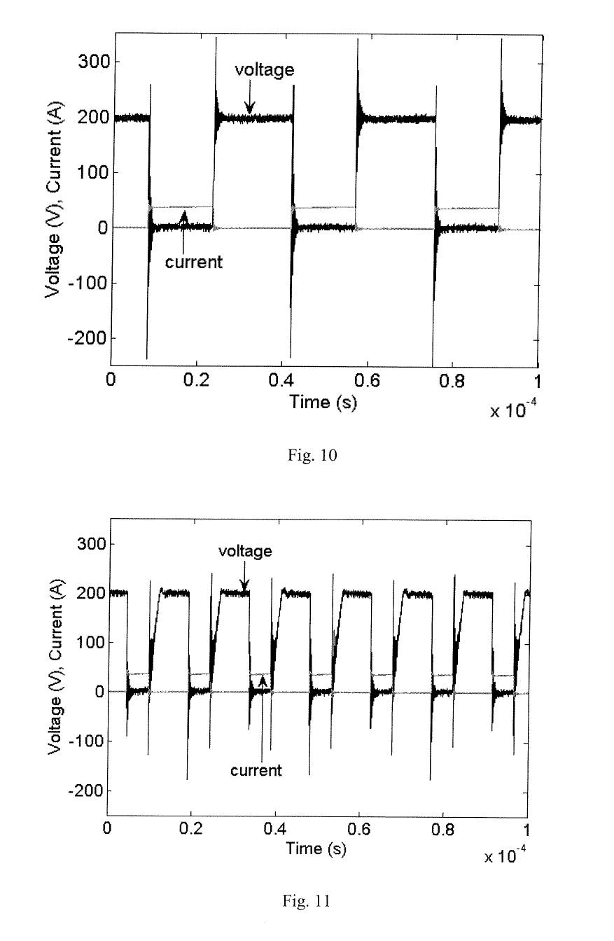

The experimental results verify the operation of the regenerative snubber circuit and match well with the PSPICE simulation results. FIG. 10 shows the voltage across and current through the switch in the hard-switched converter with a switching frequency of 30 kHz. FIG. 11 shows the much slower rate of rise of voltage across the main switch S₁ at turn off in the capacitor-switched regenerative snubber converter (with switching frequency 70 kHz), due to the charging or discharging of the snubber capacitor. FIGS. 10 and 11 also show that the maximum voltage spike (due to parasitic inductance) across the switch at turn-off is reduced from 345V in the hard-switched converter to 225V in the regenerative snubber converter, which is a 35% reduction in switch stress.

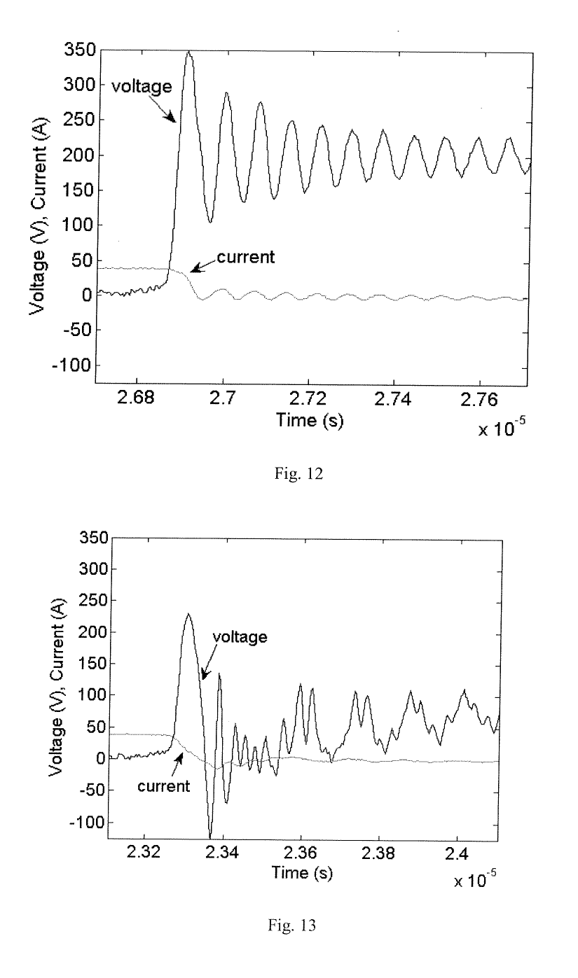

FIGS. 12 and 13 show detailed views of the voltage across and current through the main switch in the hard-switched and regenerative snubber converter respectively, during turn-off. FIG. 13 shows that the regenerative snubber circuit reduces the turn-off losses by reducing the current tail and slowing the rate of voltage rise across the switch (which also includes reducing the voltage spike due to parasitic inductance). Table II provides a quantitative comparison of the turn-off losses in both converters. The average power loss for two consecutive turn-off events is integrated over a 1 μs period (shown in FIGS. 12 and 13) to obtain the average energy loss per turn-off event for both converters. The energy loss per turn-off event for the regenerative snubber converter is reduced by 63.4% compared to the hard-switched converter. Even at a much high switching frequency (70 kHz vs. 30 kHz), the regenerative snubber converter has less power loss due to turn-off switching events than the hard-switched converter.

TABLE II
ENERGY AND POWER LOSS IN MAIN
SWITCHES AT TURN-OFF

| | Hard-Switched | Regenerative Snubber |
|---|---|---|
| | Converter | Converter |
| Energy Loss | 0.59274 mJ | 0.216745 mJ |
| Switching Frequency | 30 kHz | 70 kHz |
| Power Loss Due to Turn-Off | 17.782 W | 15.172 W |
| Switching Events | | |

FIG. 13 shows that the benefit of the slow voltage rise across the switch due to the regenerative snubber capacitor is partially negated by the voltage spike due to parasitic inductance in the prototype circuit. Thus, it is important to note that with improved circuit layout techniques, the parasitic inductance in the circuits could be further reduced. Since the current tail is significantly reduced in the regenerative snubber converter, there is a potential for greater reduction in the turn-off losses in the regenerative snubber converter if the voltage spike due to parasitic inductance can be reduced.

The switching power loss measurements are verified by comparing the experimental energy loss for the hard-switched converter to the switching losses in the IGBT datasheet [Powerex]. Equation (1) shows a general equation for calculating switching losses with an inductive load [N. Mohan, T. Undeland, and W. P. Robbins, “Power Electronics: Converters, Applications, and Design”, 2^{nd} ed., John Wiley & Sons: New York, 1995] and can be used to obtain the relation for energy loss stated in equation (2).

$${P}_{loss} = \frac{1}{2} {V}_{c} {I}_{c} {f}_{switching} ( {t}_{on} + {t}_{off} ) \qquad ( 1 )$$

Eₗₒₛₛ∝V_{c} (2)

In equations (1) and (2), V_{c} is the collector voltage across the switch when it is off, I_{c} is the collector current through the switch when it is on, f_{switching} is the switching frequency, and tₒₙ and t_{off} are the turn-on and turn-off times of the switch. The datasheet for the IGBT used in the prototypes (CM150DUS-12F) [1] specifies that for I_{c}=40 A, V_{c}=300V, and R_{g}=4.2Ω (the gate resistance used in the prototypes is similar at R_{g}=5Ω), the turn-off energy loss is approximately 1 mJ. The relation in equation (2) can be used to find the energy loss when I_{c}=40 A and V_{c}=200V (the conditions under test), as shown in equation (3):

$${E}_{loss , 200 V} = {E}_{loss , 300 V} \times \frac{200 V}{300 V} \qquad ( 3 )$$

Thus, the datasheet estimate for the turn-off energy loss is 0.667 mJ, which closely corresponds to the measured energy loss of 0.59274 mJ in the hard-switched converter. This analysis verifies that the measurement tools and methods used in this study are accurate.

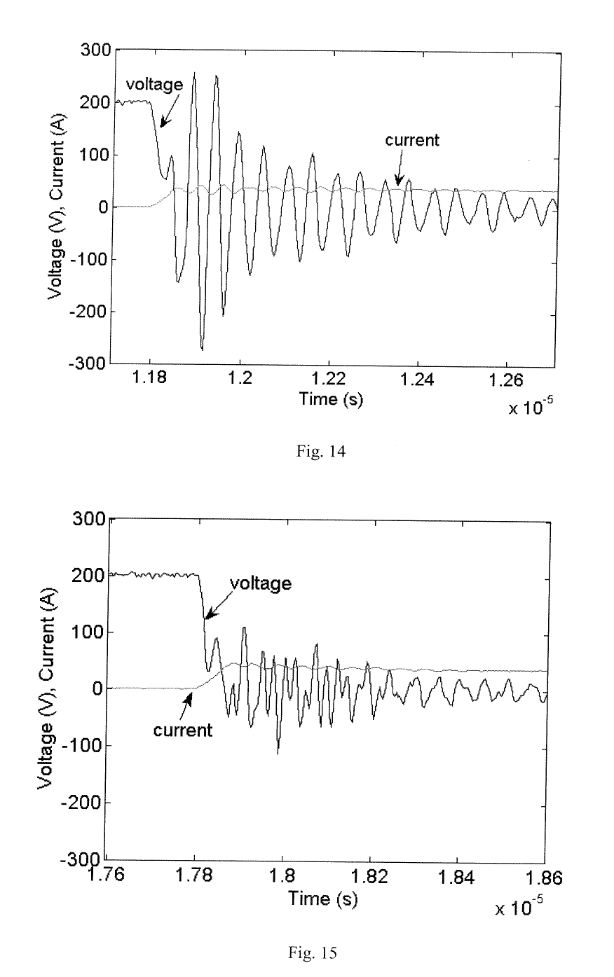

FIGS. 14 and 15 show detailed views of the voltage across and current through the main switch in the hard-switched and regenerative snubber converter respectively, during turn-on. The use of the silicon-carbide diodes, which virtually eliminates reverse recovery current, has reduced the turn-on losses in both converters to be an order of magnitude less than the turn-off losses in the hard-switched converter. FIGS. 13 and 14 also show that the switch stress is reduced in the regenerative snubber converter compared to the hard-switched converter.

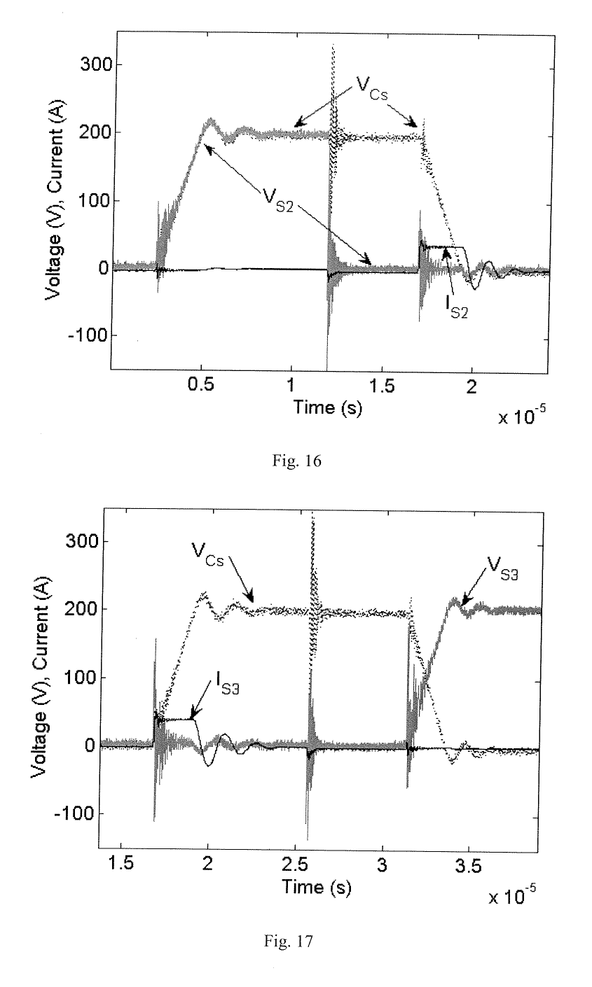

FIGS. 16 and 17 show the voltage across and current through the auxiliary switches (S₂ and S₃) as well as the snubber capacitor voltage, V_{Cs}. As expected, the auxiliary switches have virtually no switching losses, because the switch voltages are nearly zero when conduction begins and ends.

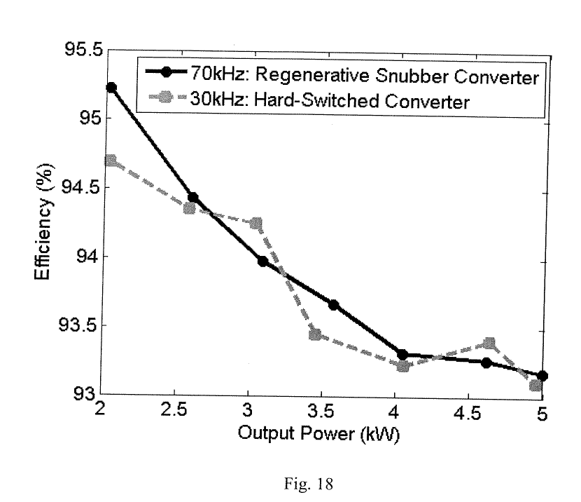

An analysis of the overall converter efficiency verifies the advantage of using the regenerative snubber circuit of the present invention. The efficiency data for each converter operating over the range 2 kW-5 kW is show in FIG. 18. FIG. 18 shows that when the hard-switched converter is operated at 30 kHz and the regenerative snubber converter is operated at 70 kHz, the efficiencies of both converters are approximately equal. Thus, it can be concluded that the use of the regenerative snubber allows a significant increase in switching frequency while maintaining high efficiency, and thus allows for a reduction in mass and cost of the passive components in the converter. For the IGBTs used in the prototype, 70 kHz is currently the maximum switching frequency. It is expected that for switches which are capable of switching at higher frequencies, even more improvement will be obtained, since the capacitor-switched regenerative snubber effectively transfers a large amount of switching losses (in the main switch) to conduction losses (in the auxiliary components) which are independent of switching frequency.

Another benefit of the regenerative snubber converter is that it requires a smaller duty cycle to achieve the same voltage boost as the hard-switched converter. The basic boost converter equation [23], shown in equation (4), is used to illustrate the results. Table III shows the measured duty cycle for two experiments, the output voltage predicted by equation (4), and the actual measured output voltage.

$$\frac{{V}_{out}}{{V}_{in}} = \frac{1}{1 - d} \qquad ( 4 )$$

TABLE III
EXPERIMENTAL DUTY CYCLE RESULTS

| | Hard-Switched | Regenerative |
|---|---|---|
| | Converter | Snubber Converter |
| Measure Input Voltage | 112.2 V | 113.0 V |
| Measured Duty Cycle | 45.0% | 37.6% |
| Expected Output Voltage | 204.0 V | 181.1 V |
| (based on equation 4) | | |
| Measured Output Voltage | 199.5 V | 201.2 V |

Table III shows that the actual output voltage of the hard-switched converter is slightly less than the expected output voltage and this is due to the known parasitic losses [Mohan]. However, the actual output voltage of the regenerative snubber converter is significantly larger (despite parasitic losses) than the expected output voltage and this is due to the transfer of energy through the auxiliary circuit to the output circuit. The extra power (above the output power if the expected output voltage were obtained) at the output of the regenerative snubber converter can be approximated by:

$${P}_{extra} = \frac{1}{2} {C ( {V}_{out} )}^{2} \times \frac{1}{2} {f}_{switching} \qquad ( 5 )$$

because the energy stored in the snubber capacitor is transferred to the output at half of the switching frequency (35 kHz in this case). Thus, the regenerative snubber converter reduces the conduction losses in the switch by reducing the duty cycle for a particular voltage boost. These conduction losses are transferred to the boost diode, allowing the main switch to operate at an even higher frequency before reaching its thermal limits.

A person skilled in the art will appreciate the numerous applications and implementations of the present invention. The following, for example, are types of converters where the capacitor switched lossless snubber of the present invention can be applied: boost converters (generally, and not just the boost converter described above in relation to the PSPICE simulation results), buck converters, unidirectional buck-boost converters, bidirectional buck-boost converter (buck in one direction, boost in the other direction). The aforesaid converters can be applied in numerous ways. (1) For example, a drivetrain of a fuel cell hybrid vehicle (i.e., fuel cell with battery energy storage system, fuel cell with ultracapacitor energy storage system, fuel cell with combined battery-ultracapacitor energy storage system). The circuit can be applied to a boost, buck, or buck-boost (bidirectional or unidirectional) wherever it is needed in the drivetrain. (2) A drivetrain of a battery-electric vehicle (i.e., battery only or combined battery-ultracapacitor drivetrain). The circuit can be applied to a boost, buck, or buck-boost (bidirectional or unidirectional) wherever it is needed in the drivetrain. (3) The drivetrain of a hybrid electric vehicle (i.e., ICE with battery energy storage system, ICE with ultracapacitor energy storage system, ICE with combined battery-ultracapacitor energy storage system). The circuit can be applied to a boost, buck, or buck-boost (bidirectional or unidirectional) wherever it is needed in the drivetrain. (4) Any other mobile application using an electric motor that requires a boost or buck in voltage to/from the electric motor to/from any energy storage system or energy source (i.e., electric riding lawnmower, electric bicycle, forklifts, buses, trucks, military vehicles, aircraft, watercraft, etc.). (5) In vehicle or other mobile applications which have a high-voltage bus to power an electric motor, there is usually a DC/DC buck converter that reduces the high voltage to a lower voltage such as 12V or 42V to power auxiliary loads (i.e. lights, radio, controllers, power steering, etc.) Since the capacitor-switched lossless snubber is applicable to a buck converter, it can be applied in this area as well. (6) Stationary applications which require a voltage buck and/or boost from an energy storage system (such as batteries, ultracapacitors, flywheels, etc.) or from an energy source (fuel cells, photovoltaic cells, etc.). This includes UPS (uninterruptible power supplies) which are used in various buildings (hospitals, government buildings, university buildings, police stations, fire stations, etc.). (7) Some microturbine-based generating units use a boost converter in the AC/AC conversion stage between the diode rectifier and the switch-mode inverter to increase the dc-bus voltage level. The power rating of this boost converter ranges from 50 to a couple of hundred kilowatts. It is important to improve the efficiency of the overall system and reduce the weight and volume of the system. A boost converter equipped with the capacitor-switched lossless snubber of the present invention can realize both objectives. (8) The capacitor-switched lossless snubber may be applied in any other area not mentioned above, where a buck converter, boost converter, unidirectional buck-boost converter, or bidirectional buck-boost converter is used.

It will be appreciated by those skilled in the art that other variations of the preferred embodiment may also be practised without departing from the scope of the invention.

What is claimed is:

1. In a power converter having a power switch, a snubber circuit comprising:
a snubber capacitor;
first and second snubber diodes;
a first auxiliary switch that, upon a first turn off of the power switch, conducts current through the first snubber diode and the snubber capacitor to charge the snubber capacitor; and
a second auxiliary switch that upon a subsequent turn off of the power switch, conducts current through the second snubber diode and the snubber capacitor to discharge the snubber capacitor.

2. The snubber circuit of claim 1, wherein the power converter is a boost converter.

3. The snubber circuit of claim 2, wherein the boost converter includes a silicon-carbide boost diode.

4. The snubber circuit of claim 1, wherein the first and second auxiliary switch are IGBTs.

5. A method for minimizing switch off losses in a power converter having an input current, a power switch set in an on position and a snubber circuit, the snubber circuit having a first auxiliary switch, a second auxiliary switch, a snubber capacitor, and first and second snubber diodes, the method comprising the steps of:
i) setting the first auxiliary switch to an on position and the second auxiliary switch to an off position;
ii) charging the snubber capacitor from zero V to Vₒᵤₜ by setting the power switch to an off position to divert the current through the first snubber diode, the snubber capacitor and the first auxiliary switch;
iii) setting the first auxiliary switch to an off position;
iv) setting the power switch to the on position;
v) setting the second auxiliary switch to an on position;
vi) discharging the snubber capacitor from Vₒᵤₜ to zero V by setting the power switch to the off position to divert the current through the second snubber diode, the snubber capacitor and the second auxiliary switch; and
vii) repeating steps i) through vii).

6. The method of claim 5, wherein the power converter is a boost converter.

7. The method of claim 6, wherein the boost converter includes a silicon-carbide boost diode.

8. The method of claim 5, wherein the first and second auxiliary switches are IGBTs.

9. The method of claim 5, wherein the first and second auxiliary switches are switched under zero voltage conditions.

10. A power converter having a snubber circuit, the snubber circuit comprising:
a snubber capacitor;
first and second snubber diodes;
a first auxiliary switch that, upon a first turn off of the power switch, conducts current through the first snubber diode and the snubber capacitor to charge the snubber capacitor; and
a second auxiliary switch that upon a subsequent turn off of the power switch, conducts current through the second snubber diode and the snubber capacitor to discharge the snubber capacitor.

11. The power converter of claim 10, wherein the power converter is a boost converter.

12. The power converter of claim 11, wherein the boost converter includes a silicon-carbide boost diode.

13. The power converter of claim 10, wherein the first and second auxiliary switches are IGBTs.
